(19) United States
(12) Patent Application Publication
(10) Pub. No.: US 2006/0028403 A1
(43) Pub. Date: Feb. 9, 2006

(54) Plasma discharge switch and current driving device having the same

(76) Inventors: Ho-nyeon Lee, Seongnam-si (KR); Hidekazu Hatanaka, Seongnam-si (KR); Young-mo Kim, Suwon-si (KR); Seung-hyun Son, Hwaseong-si (KR); Sang-hun Jang, Yongin-si (KR); Seong-eui Lee, Seongnam-si (KR); Gi-young Kim, Yongin-si (KR); Hyoung-bin Park, Seongnam-si (KR)

Correspondence Address: MCGUIREWOODS, LLP, 1750 TYSONS BLVD, SUITE 1800, MCLEAN, VA, 22102, US

(21) Appl. No.: 11/094,148

(22) Filed: Mar. 31, 2005

(30) Foreign Application Priority Data
Aug. 3, 2004 (KR) 10-2004-0061089

(51) Int. Cl. G09G 3/28

(52) U.S. Cl. 345/60

(57) ABSTRACT

A plasma discharge switch and a current driving device including the switch. The plasma discharge switch, which switches a flow of electric current between a first electrode and a second electrode by generating and extinguishing a plasma discharge in a discharge cell, includes a discharge cell. A first electrode and a second electrode are disposed in each discharge cell to generate a plasma discharge in the discharge cell so that electric current may flow between the first and second electrodes during the plasma discharge.

### CROSS REFERENCE TO RELATED APPLICATION

This application claims priority to and the benefit of Korean Patent Application No. 10-2004-0061089, filed on Aug. 3, 2004, which is hereby incorporated by reference for all purposes as if fully set forth herein.

### BACKGROUND OF THE INVENTION

1. Field of the Invention

The present invention relates to a plasma discharge switch and a current driving device including the switch, and more particularly, to a plasma discharge switch using current switching characteristics of a plasma discharge generated in a discharge cell.

2. Discussion of the Background

Generally, flat panel displays such as plasma display panels (PDPs), organic light emitting devices (OLEDs), liquid crystal displays (LCDs), and field emission displays (FEDs), are becoming increasingly popular.

The PDP forms images using plasma discharge, and it is widely used since it displays bright images and has a wide viewing angle. In the PDP, applying voltages to discharge cell electrodes generates the plasma discharge, thereby generating ultraviolet rays that excite phosphors to emit visible light.

FIG. 1 shows a conventional surface discharge type PDP. FIG. 2A and FIG. 2B show cross sections of the PDP along a direction crossing an address electrode and a direction parallel to the address electrode.

Referring to FIG. 1, FIG. 2A, and FIG. 2B, the conventional PDP may include an upper substrate 20 and a lower substrate 10 facing each other with a predetermined gap therebetween. A space between the substrates is a discharge space where plasma discharge occurs.

A plurality of stripe-shaped address electrodes 11 is arranged on an upper surface of the lower substrate 10, and a first dielectric layer 12 covers the address electrodes 11. A plurality of barrier ribs 13, which define discharge cells 14 and prevent electrical and optical cross talk between discharge cells 14, are formed on an upper surface of the first dielectric layer 12. Additionally, red (R), green (G), and blue (B) phosphor layers 15 are formed in the discharge cells 14, which are filled with a discharge gas.

The upper substrate 20 may be a transparent, glass substrate, and it is coupled to the lower substrate 10. Pairs of stripe-shaped sustain electrodes 21a and 21b are formed on a lower surface of the upper substrate 20 in a direction crossing the address electrodes. The sustain electrodes 21a and 21b are generally formed of transparent conductive material, such as indium tin oxide (ITO). Additionally, bus electrodes 22a and 22b, which are narrower than the sustain electrodes 21a and 21b, are formed on lower surfaces of the sustain electrodes 21a and 21b . A transparent second dielectric layer 23 covers the sustain electrodes and the bus electrodes, and a protective layer 24, which may be formed of MgO, covers the second dielectric layer 23.

A PDP having the above structure is driven for address discharge and sustain discharge. The address discharge occurs between the address electrode 11 and one of the sustain electrodes 21a and 21b, to form wall charges. The sustain discharge occurs due to a difference between electric potentials of the sustain electrodes 21a and 21b, and it generates the ultraviolet rays that excite the phosphor layer to emit visible rays.

The OLED converts electric energy into optical energy using an organic material. A hole and an electron from an anode and a cathode recombine in an organic layer to generate an exciton, which emits light when transitioning from an excited to ground state. The OLED may be made thin, and it may have low power consumption and fast response speed.

FIG. 3 is a schematic cross sectional view showing an OLED. Referring to FIG. 3, the OLED includes a sequentially stacked anode electrode 31, light emitting layer 35, and cathode electrode 41. Additionally, a poly-Si thin film transistor (TFT) array or an a-Si TFT array may be used as a switching device for driving the OLED.

However, fabricating such a TFT array may be complicated and expensive. Additionally, since the poly-Si TFT array may have low uniformity, a mura may occur on the display screen. The a-Si TFT array may have a short life-span, thus it is may not be practical.

In order to solve the above problems, the present invention uses a plasma discharge switch as a switching device for driving an OLED. As noted above, the conventional PDP uses the plasma discharge to display images. However, according to exemplary embodiments of the present invention, a discharge cell is used as a switching array for driving a current driven device, such as the OLED, using the plasma discharge's switching characteristics and data storage function.

### SUMMARY OF THE INVENTION

The present invention provides a plasma discharge switch using a switching characteristic and a data storage characteristic of a plasma discharge, and a current driving device including the switch.

Additional features of the invention will be set forth in the description which follows, and in part will be apparent from the description, or may be learned by practice of the invention.

The present invention discloses a plasma discharge switch including a discharge cell comprising a first electrode and a second electrode to generate a plasma discharge in the discharge cell so that electric current may flow between the first and second electrodes during the plasma discharge. The switch switches a flow of electric current between the first electrode and the second electrode by generating and extinguishing a plasma discharge in the discharge cell.

The present invention also discloses a current driving device including a plasma discharge switch that includes a discharge cell comprising a first electrode and a second electrode for generating a plasma discharge in the discharge cell so that electric current may flow between the first and second electrodes during the plasma discharge. The plasma discharge switch switches a flow of electric current between the first electrode and the second electrode by generating and extinguishing a plasma discharge in the discharge cell.

The present invention also discloses an organic light emitting device including a plasma discharge switch and a display cell. The plasma discharge switch is formed between first and second substrates and it includes a discharge cell comprising a first electrode and a second electrode. A display cell includes the second electrode, a third electrode formed on the second substrate, and an organic light emitting layer between the second electrode and the third electrode. The present invention also discloses an organic light emitting device including a plasma discharge switch and a display cell. The plasma discharge switch includes a discharge cell formed in upper portion of a space between a first substrate and a second substrate, and comprising a first electrode and a second electrode. A display cell is formed in a lower portion of the space between the first substrate and the second substrate and it includes the second electrode, a third electrode formed on the second substrate, and an organic light emitting layer formed between the second electrode and the third electrode.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is an exploded perspective view showing a conventional PDP.

FIG. 2A is a cross-sectional view showing the PDP of FIG. 1.

FIG. 2B is a second cross-sectional view showing the PDP of FIG. 1.

FIG. 3 is a schematic cross-sectional view showing a conventional OLED.

FIG. 4 is a plan view showing a part of an OLED including a plasma discharge switch according to an exemplary embodiment of the present invention.

FIG. 5 is a cross-sectional view along line V-V′ of FIG. 4.

FIG. 6 is a cross-sectional view along line VI-VI′ of FIG. 4.

FIG. 7 is a schematic block diagram showing the OLED of FIG. 4.

FIG. 8A is an equivalent circuit diagram showing the OLED with a plasma discharge switch turned off according to an exemplary embodiment of the present invention.

FIG. 8B shows voltages that may be applied to electrodes in a state where the plasma discharge switch is off.

FIG. 9A is an equivalent circuit diagram showing the OLED with the plasma discharge switch turned on according to an exemplary embodiment of the present invention.

FIG. 9B shows voltages that may be applied to the electrodes in a state where the plasma discharge switch is on.

FIG. 10 is a cross-sectional view showing an OLED according to another exemplary embodiment of the present invention.

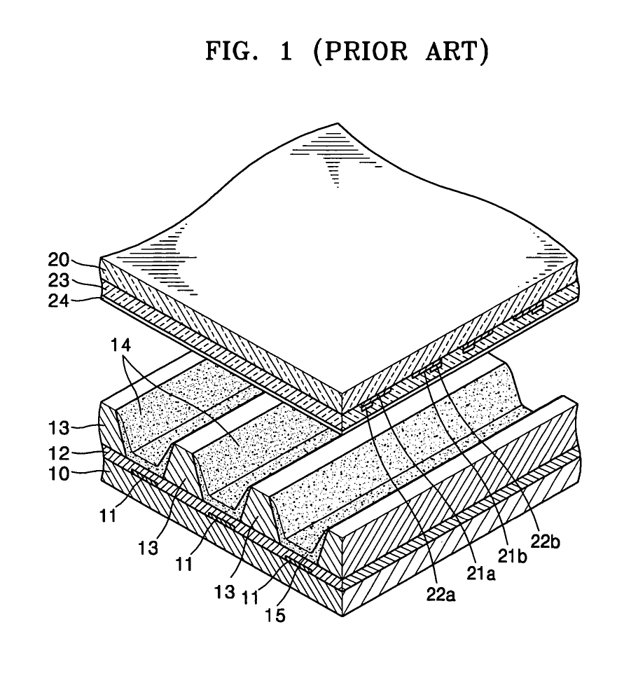

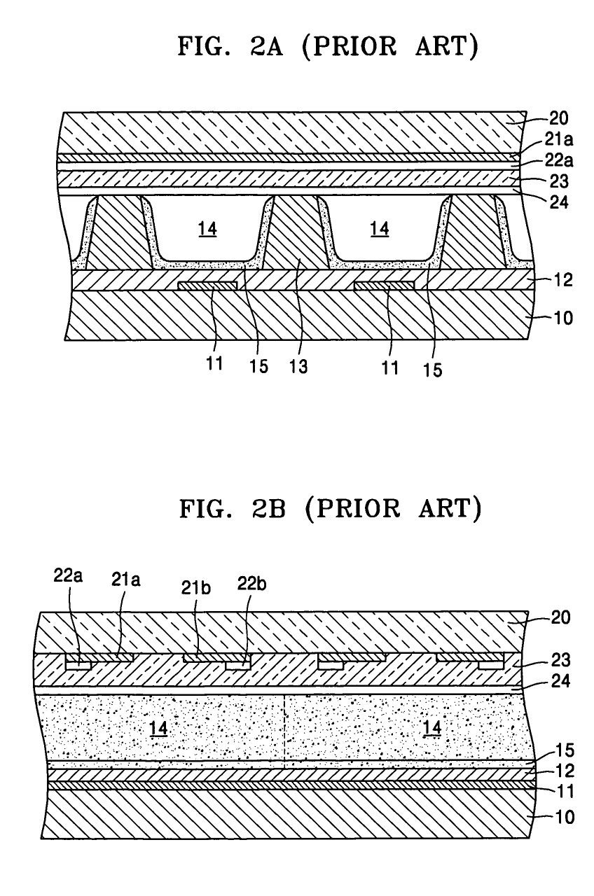

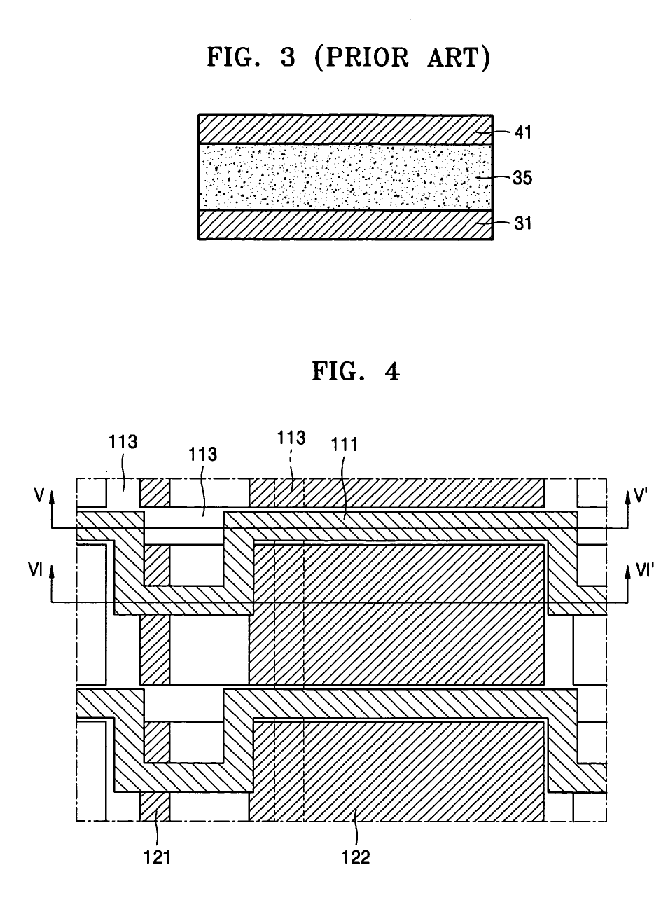

### DETAILED DESCRIPTION OF THE ILLUSTRATED EMBODIMENTS

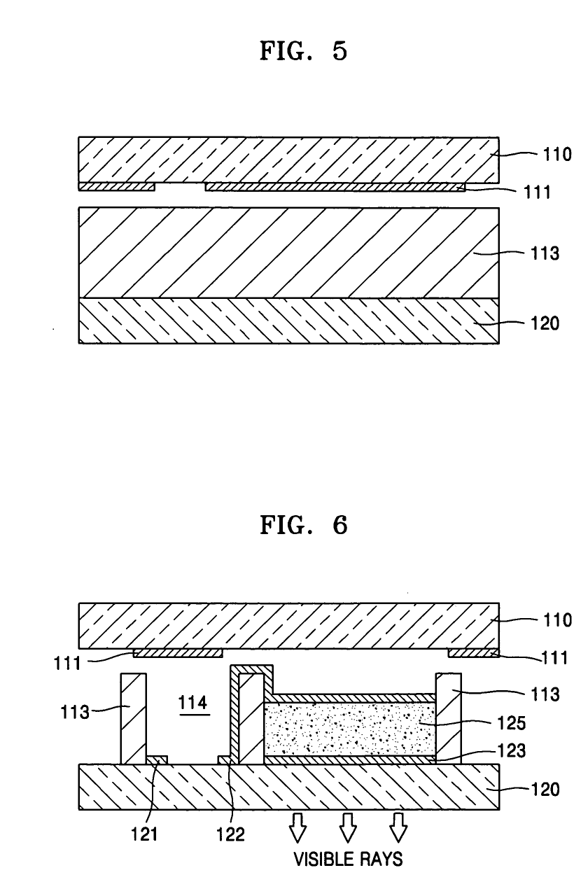

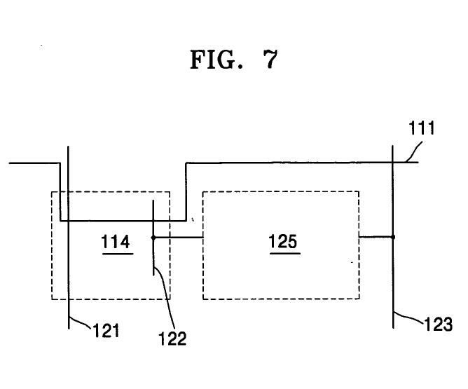

FIG. 4 is a plan view showing a part of an OLED including a plasma discharge switch according to an exemplary embodiment of the present invention. FIG. 5 is a cross-sectional view showing the OLED along line V-V′ of FIG. 4, and FIG. 6 is a cross-sectional view showing the OLED along line VI-VI′ of FIG. 4. FIG. 7 is a schematic block diagram showing the OLED of FIG. 4.

Referring to FIG. 4, FIG. 5, FIG. 6 and FIG. 7, the OLED may include a plurality of plasma discharge switches and a plurality of corresponding display cells, which emit light to display images.

The plasma discharge switch may include a first substrate 110 and a second substrate 120, a discharge cell 114 formed between the first and second substrates 110 and 120, and discharge electrodes generating the plasma discharge in the discharge cell.

Additionally, the display cell may be formed between the first and second substrates 110 and 120. The display cells may be formed on the same plane as the discharge cells 114, and corresponding discharge cells and display cells may be formed adjacent to each other.

The first and second substrates 110 and 120 face each other with a predetermined gap therebetween. They may be formed of a transparent material, such as glass, so that visible rays may transmit therethrough.

Additionally, a plurality of barrier ribs 113, which maintain the gap between the first and second substrates 110 and 120 and partition the space between the substrates to form the discharge cells 114 and the display cells, may be disposed between the first and second substrates. A discharge gas is filled in the discharge cells 114.

The plasma discharge switch's discharge electrodes may include an address electrode 111 and a pair of first and second electrodes 121 and 122, which are formed at each discharge cell 114. The address electrode 111 performs an address discharge, and it may be formed on a lower surface of the first substrate 110. The first and second electrodes 121 and 122 perform a sustain discharge, and they may be formed on an upper surface of the second substrate 120, in parallel to each other, and in a direction crossing the address electrode 111. The address electrode 111 and the first and second electrodes 121 and 122 may be formed of a transparent conductive material, such as indium tin oxide (ITO).

The second electrode 122 may also be positioned at an upper portion of the display cell. Thus, it may extend from the upper surface of the second substrate 120, along a sidewall and over the top of the barrier rib 113, to the upper portion of the display cell. Additionally, a third electrode 123 may be formed on the upper surface of the second substrate 120 at a lower portion of the display cell. An organic light emitting layer 125 may be formed between the second and third electrodes 122 and 123. An electric potential difference applied between the second and third electrodes 122 and 123 may inject a hole and an electron, respectively, into the light emitting layer 125. Here, the second and third electrodes 122 and 123 are, for example, an anode electrode and a cathode electrode, respectively.

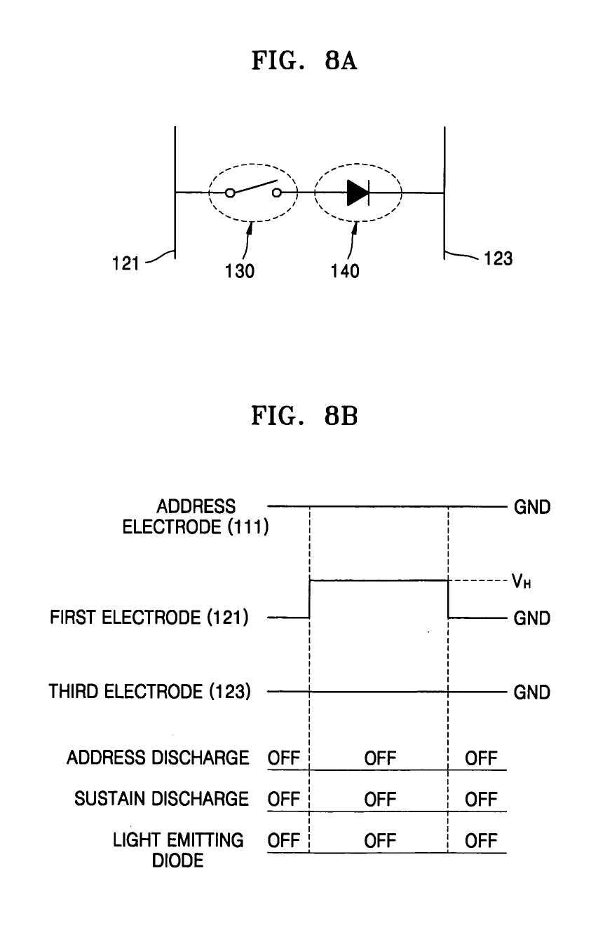

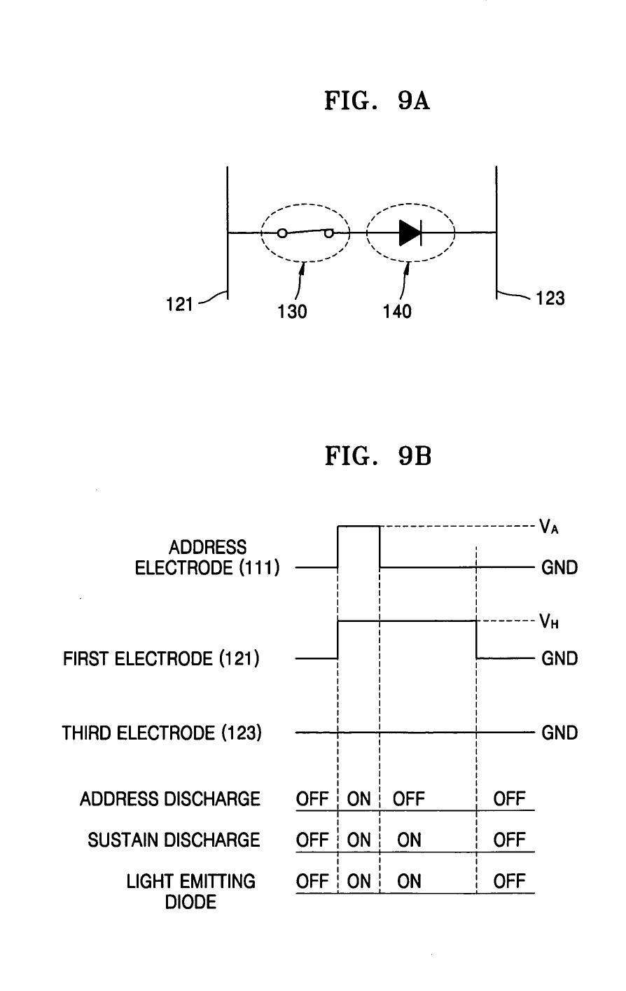

Hereinafter, operations of the OLED will be described with reference to FIG. 7, FIG. 8A, FIG. 8B, FIG. 9A, and FIG. 9B.

FIG. 8A is an equivalent circuit diagram showing the OLED in a state where the plasma discharge switch is off. In FIG. 8A, reference numeral 130 denotes the plasma discharge switch that switches current flow between the first electrode 121 and the second electrode (122 in FIG. 7) by plasma discharge, and reference numeral 140 denotes a light emitting diode that is coupled to the plasma discharge switch 130. FIG. 8B shows voltages that may be applied to electrodes in a state where the plasma discharge switch is off.

Referring to FIG. 8A and FIG. 8B, when biasing the address electrode 111 at a ground voltage GND, the address discharge and the sustain discharge do not occur even though a voltage difference V_{H} exists between the first electrode 121 and the third electrode 123. Therefore, since electric current does not flow between the first electrode 121 and the second electrode (122 in FIG. 7), the plasma discharge switch 130 is off. Additionally, in this state, the voltage difference between the second electrode 122 and the third electrode 123 does not cause the light emitting diode 140 to emit light.

FIG. 9A is an equivalent circuit diagram showing the OLED in a state where the plasma discharge switch is on. FIG. 9B shows voltages that may be applied to the electrodes to turn on the plasma discharge switch.

Referring to FIG. 9A and FIG. 9B, applying a voltage V_{A} to the address electrode 111, in a state where a voltage difference V_{H} exists between the first electrode 121 and the third electrode 123, may generate the address discharge in the discharge cell (114 in FIG. 7). The address discharge occurs between the address electrode 111 and the second electrode 122 of FIG. 6 and FIG. 7, and it generates the sustain discharge between the first and second electrodes 121 and 122. The sustain discharge forms a path for electric current in the discharge cell 114, and current may flow between the first and second electrodes 121 and 122. Hence, the plasma discharge switch turns on. In this status, a predetermined voltage may be applied to the second electrode 122 through the first electrode 121, thereby generating a voltage difference between the second electrode 122 and the third electrode 123. Accordingly, electrons and holes may be injected into the organic light emitting layer (125 in FIG. 7) and combined so that the light emitting diode 140 emits light. The generated, visible light may exit through the second substrate 120 to form an image, as arrows in FIG. 6 indicate.

Further, in the plasma discharge switch, the memory effect, which is caused by excited particles that are generated by the plasma discharge, may function as a memory device of a general active matrix switching array.

As described above, a discharge cell comprises the address electrode 111 and a pair of first and second electrodes 121 and 122. However, the address electrode is not required, and a discharge cell may comprise a pair of first and second electrodes. In this case, the first and second electrodes may be formed on the first and second substrates 110 and 120, respectively. Alternatively, the first and second electrodes may be formed on either the first or second substrate.

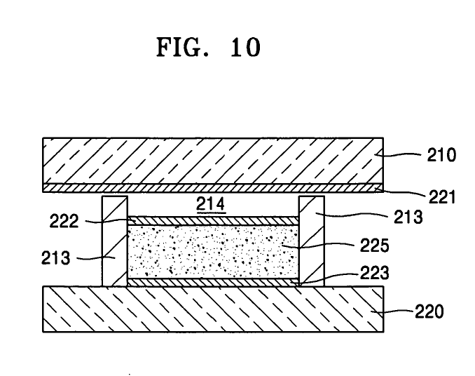

FIG. 10 is a cross-sectional view showing part of an OLED including a plasma discharge switch according to an exemplary embodiment of the present invention.

Referring to FIG. 10, the OLED includes a plurality of plasma discharge switches and a plurality of display cells, coupled to the plasma discharge switches, to display images.

Referring to FIG. 10, a plasma discharge switch may include a first substrate 210 and a second substrate 220 facing each other with a predetermined gap therebetween, a discharge cell 214 formed at an upper portion of a space between the first and second substrates, and discharge electrodes for performing plasma discharge in the discharge cell 214.

A display cell may be formed at a lower portion of the space between the first and second substrates 210 and 220 to correspond to the discharge cell 214.

The plasma discharge switch's discharge electrodes may include a pair of first and second electrodes 221 and 222 for each discharge cell 214. The first electrode 221 may be formed on a lower surface of the first substrate 210, and the second electrode 222 may be formed on an upper portion of the display cell to cross the first electrode 221. The first and second electrodes 221 and 222 may be formed of a transparent conductive material, such as ITO.

A plurality of barrier ribs 213 may be disposed between the first and second substrates 210 and 220. The barrier ribs 213 maintain an interval between the first and second substrates, and they partition the space between the first and second substrates to form the discharge cells 214 and the display cells. A discharge gas may be filled in the discharge cells 214.

As described above, the second electrode 222 is positioned at an upper portion of the display cell. Additionally, a third electrode 223 may be formed on an upper surface of the second substrate 220. An organic light emitting layer 225 may be formed between the second and third electrodes 222 and 223. Here, the second and third electrodes 222 and 223, for example, may be the anode electrode and the cathode electrode, respectively.

In such an OLED, a predetermined voltage may be applied between the first electrode 221 and the second electrode 222 to generate the address discharge between them. Applying the sustain voltage between the first electrode 221 and the second electrode 222 may maintain the discharge in the discharge cell 214. Thus, a current path forms in the discharge cell 214, and electric current flows between the first electrode 221 and the second electrode 222. Additionally, the flow of electric current may generate a predetermined voltage difference between the second electrode 222 and the third electrode 223. Accordingly, electrons and holes may be injected into the organic light emitting layer 225 and combined to generate visible rays. If the address discharge does not occur between the first electrode 221 and the second electrode 222, the plasma discharge is not generated in the discharge cell 214. Thus, electric current does not flow between the first electrode 221 and the second electrode 222, and the organic light emitting layer 225 does not emit light.

The exemplary embodiments above describe an OLED having the plasma discharge switch. However, the present invention is not limited to the OLED. It may be applied to various current driven devices using the plasma discharge switch as the current switching device.

According to exemplary embodiments of the present invention, the discharge cells are used as the switching arrays for driving the current driven device, such as the OLED, using the plasma discharge's switching characteristic and data storage characteristic. Thus, a large switching array may be manufactured cheaply.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A plasma discharge switch, comprising:
a discharge cell comprising a first electrode and a second electrode;
wherein the first electrode and the second electrode generate a plasma discharge in the discharge cell so that electric current flows between the first electrode and the second electrode during the plasma discharge,
wherein the plasma discharge switch switches a flow of electric current between the first electrode and the second electrode by generating and extinguishing a plasma discharge in the discharge cell.

2. The switch of claim 1, further comprising:
a first substrate; and
a second substrate,
wherein the discharge cell is between the first substrate and the second substrate.

3. The switch of claim 2,
wherein the first electrode is formed on the first substrate, and
wherein the second electrode is formed on the second substrate.

4. The switch of claim 2, wherein the first electrode and the second electrode are formed on either the first substrate or the second substrate.

5. The switch of claim 2, wherein the discharge cell further comprises:
an address electrode,
wherein the address electrode performs an address discharge.

6. The switch of claim 5,
wherein the address electrode is formed on the first substrate, and
wherein the first electrode and the second electrode are formed on the second substrate and in a direction crossing the address electrode.

7. The switch of claim 1, wherein a discharge gas is in the discharge cell.

8. A current driving device comprising the plasma discharge switch of claim 1,
wherein the plasma discharge switch switches a flow of electric current between the first electrode and the second electrode by generating and extinguishing a plasma discharge in the discharge cell.

9. The device of claim 8, wherein the discharge cell further comprises:
an address electrode,
wherein the address electrode performs an address discharge.

10. The device of claim 8, wherein a discharge gas is in the discharge cell.

11. An organic light emitting device, comprising:
a first substrate and a second substrate;
a plasma discharge switch having a discharge cell formed between the first substrate and the second substrate;
a display cell,
wherein the discharge cell comprises a first electrode and a second electrode, and
wherein the display cell comprises:
the second electrode,
a third electrode formed on the second substrate, and
an organic light emitting layer formed between the second electrode and the third electrode.

12. The device of claim 11, wherein the discharge cell and the display cell are formed on a same plane.

13. The device of claim 12, wherein the discharge cell and the display cell are formed to be adjacent to each other.

14. The device of claim 12, further comprising:
a plurality of barrier ribs between the first substrate and the second substrate,
wherein the barrier ribs partition a space between the first substrate and the second substrate to define discharge cells and display cells.

15. The device of claim 12, wherein the second electrode extends from the discharge cell to an upper portion of the display cell.

16. The device of claim 11,
wherein the first electrode is formed on the first substrate, and
wherein the second electrode is formed on the second substrate.

17. The device of claim 11, wherein the first electrode and the second electrode are formed on the second substrate.

18. The device of claim 11, wherein the discharge cell further comprises an address electrode.

19. The device of claim 18,
wherein the address electrode is formed on the first substrate, and
wherein the first electrode and the second electrode are formed on the second substrate and in a direction crossing the address electrode.

20. The device of claim 11, wherein a discharge gas is in the discharge cell.

21. An organic light emitting device, comprising:
a first substrate and a second substrate;
a plasma discharge switch having a discharge cell formed in an upper portion of a space between the first substrate and the second substrate;
a display cell formed in a lower portion of the space between the first substrate and the second substrate,
wherein the discharge cell comprises a first electrode and a second electrode, and
wherein the display cell comprises the second electrode, a third electrode formed on the second substrate, and an organic light emitting layer formed between the second electrode and the third electrode.

22. The device of claim 21, wherein the first electrode is formed on the first substrate and in a direction crossing the second electrode.

23. The device of claim 21, further comprising:
a plurality of barrier ribs between the first substrate and the second substrate,
wherein the barrier ribs partition a space between the first substrate and the second substrate to form discharge cells and display cells.

24. The device of claim 21, wherein a discharge gas is in the discharge cell.
